(19) United States
(12) Patent Application Publication
(10) Pub. No.: US 2021/0368665 A1
(43) Pub. Date: Dec. 2, 2021

(54) Device and method for mechanical weed control

(71) Applicant: Bähr Bau- und Landmaschinen GmbH & Co. KG, llbesheim (DE)

(72) Inventor: Oliver BÄHR, Göcklingen (DE)

(21) Appl. No.: 17/285,141

(22) PCT Filed: Oct. 17, 2019
(86) PCT No.: PCT/EP2019/078151

§ 371 Date: Apr. 14, 2021

(30) Foreign Application Priority Data
Oct. 18, 2018 (DE) 10 2018 125 940.9

(51) Int. Cl. A01B 39/18; A01B 19/02; A01B 23/02; A01B 35/12; A01B 39/16; A01B 35/18

(52) U.S. Cl. CPC A01B 39/18; A01B 19/02; A01B 35/18; A01B 35/12; A01B 39/163; A01B 23/02

(57) ABSTRACT

A device and method for mechanical weed control. The device comprises an agricultural vehicle having a predetermined direction of travel and two opposite longitudinal sides, and a tillage device attached to the agricultural vehicle. The tillage device comprises at least one harrow with at least one tine comprising a tine arm, a tine tip and a tine base, and the tine tip and the tine base are located at opposite ends of the tine arm. The harrow is connected in the region of the tine base to a connecting element, wherein the at least one tine of the harrow has a bend with a predetermined angle and wherein at least the tine tip projects beyond a longitudinal side of the agricultural vehicle and the tine arm is oriented at a predetermined angle with respect to the direction of travel.

### TECHNICAL FIELD

The present invention relates to a device and a method for mechanical weed control. In particular, the invention relates to a device and a method for mechanical weed control in row-planted crops with lignified ground shoots or trunks.

### STATE OF THE ART

There is a variety of crop plants, which can essentially be divided into two large groups. On the one hand, there are the annual or herbaceous plants, such as cereals or potatoes, which are mainly found in classic arable farming. On the other hand, there are a number of perennial or long-standing crop plants, which are often comparatively large due to their age and usually have a lignified ground shoot or a trunk. The latter group includes, for example, vines or fruit trees, but also Christmas trees, berry bushes, roses or shrubs with lignified shoots.

With all crop plants there is the problem that not only the crop plants grow on the cultivated land, but also undesirable weeds. The weeds interfere with the cultivation of the crop plants. In addition, the weeds have a negative effect on the desired yield and quality of the harvested fruit. For these reasons, the undesirable weeds are usually removed.

An effective means of removing the undesirable weeds is the use of chemical agents. However, in terms of an environmentally sound agriculture, the goal is to avoid or minimize the use of chemical agents. As an alternative to the use of chemical agents, the undesirable weeds can be removed or pulled out of the soil by using tillage devices.

Typically, crops are planted in rows to facilitate cultivation. For crops that have lignified ground shoots or trunks, the problem is that undesirable weeds grow between rows of plants and between individual plants in a row of plants. These intra-row weeds though cannot be removed satisfactorily, if at all, with conventional tillage equipment familiar from arable farming.

For this reason, especially in viticulture, special roller weeders and finger weeders have been developed to pull out or damage the undesirable weeds, causing them to die off. However, the finger weeder and the roller weeder do not always reach the weeds that are directly near the trunk of the crop plants.

In addition, the roller weeder breaks up the top layer of soil to damage or remove the undesirable weeds from the soil. This can leave a rather rough soil surface between the rows of plants after the ground has been worked. The latter can result in an unsightly appearance of a tilled vineyard or orchard. It also makes it difficult to walk in the vineyard or orchard for inspecting the plants or other plant-care procedures.

### DESCRIPTION OF THE INVENTION

Therefore, it is the object of the present invention to provide a device and method for mechanical weed control that reliably removes undesirable weeds and leaves a smoothed soil surface.

According to the invention, the problem is solved by a device for mechanical weed control, comprising an agricultural vehicle having a predetermined direction of travel and two opposite longitudinal sides, and a tillage device attached to the agricultural vehicle, wherein the tillage device comprises at least one harrow having at least one tine comprising a tine arm, a tine tip and a tine base, wherein the tine tip and the tine base are located at opposite ends of the tine arm, wherein the harrow is connected in the region of the tine base to a connecting element, wherein the at least one tine of the harrow has a bend with a predetermined angle, wherein at least the tine tip projects beyond a longitudinal side of the agricultural vehicle and wherein the tine arm is oriented at a predetermined angle with respect to the direction of travel.

The predetermined and, in particular, adjustable angle hereinafter is also referred to as the setting angle.

The harrow can be attached to the front, rear or side of the agricultural vehicle. In particular, when the harrow is attached to the side of the agricultural vehicle, the at least one tine typically projects completely beyond the longitudinal side of the agricultural vehicle. When the harrow is attached to the front or rear of the agricultural vehicle, the at least one tine may project partially or completely beyond the longitudinal side of the agricultural vehicle.

By means of the device for mechanical weed control, it is now possible that weed plants can even be grasped directly near the wooden trunk of the crop plants and thus pulled out. The at least one tine of the harrow can be brought right up to the crop plant safely in order to grasp the weeds, since the at least one tine, in contrast to a roller weeder, does not or does not seriously damage the trunk of a crop plant, such as a vine or fruit tree.

The provision of a bend in the tine on the one hand leads to improved protection of the crop plants and, on the other hand, it allows adapting the mode of operation of the harrow to the external conditions due to the variable predetermined angle of the bend. The bend in the tine can be provided in the tine tip, in the tine arm or between the tine tip and the tine arm.

Weed control is particularly effective when the tine arm is inclined downwards, wherein the tine arm is preferably oriented rearwards regarding the direction of travel, as the uprooted weeds are then pulled away from the crop plants.

Preferably, the device is adapted to cultivate row crops having a stem and a crown, wherein the harrow is mounted on the agricultural vehicle in such a way that cultivation of the crop by means of the harrow takes place below the crown of the crop plants. In this way, the soil around the crop plants can be tilled without the risk of damaging the crop plants. In this context, crown means the branches or shoots of a crop plant.

In a preferred embodiment, the setting angle of the at least one tine relative to the horizontal is less than 45°, preferably less than 30°. A predetermined setting angle relative to the horizontal has the advantage that, in the vicinity of the vehicle, the harrow can be guided at a distance from the ground, while in the area of the crop plant the harrow can engage the ground. This prevents weeds from being pulled out in the area close to the vehicle. For ecological reasons, this may be desirable. In addition, these weeds in the vicinity of the vehicle thus do not impair the effectiveness of the harrow. The angle should not be greater than 45°, because a comparatively flat alignment of the tines is particularly desirable in the case of vines, as the harrow is then only guided below the shoots along the trunk of the vine and thus does not damage the shoots of the vine.

In a preferred embodiment, the vertical distance of the tine base from a contact surface of the agricultural vehicle is about 20 cm to 70 cm, preferably 20 cm to 50 cm. In this context, contact surface means the surface on the underside of the agricultural vehicle with which the agricultural vehicle, in particular with which the wheels of the agricultural vehicle, rests on the ground, such as the soil to be tilled or the road. This measure also helps to ensure that the harrow is guided below the shoots of a crop plant to prevent damage to the crop plant. In addition, the aforementioned distance of 20 cm to 50 cm has proven to be optimal, as the distance to the ground and thus to the weeds is large enough not to influence the weeds, especially in the vicinity of the agricultural vehicle, in an undesirable way during operation, and small enough to effectively remove the weeds from the soil.

In order to adjust the angle between the harrow and the direction of travel of the vehicle, in particular to adjust the angle between the tine of the harrow and the direction of travel of the vehicle, preferably an adjustment device is provided.

It is of particular advantage that the adjustment device is designed to adjust the harrow in at least one spatial direction, preferably in three mutually perpendicular spatial directions. Thus, the angle of the harrow relative to the direction of travel as well as the vertical position of the tine tip and the angle of the tine in relation to the soil to be tilled can be adjusted.

To ensure easy adjustment of the adjustment device, the adjustment device preferably has at least one lockable joint, in particular a toothed joint.

In a further development of the device for mechanical weed control, it is provided that the adjustment device is firmly connected to the connecting element of the harrow. The advantage of this is that further tillage devices can be easily connected to the agricultural vehicle.

It is further advantageous that the at least one tine is formed springily to avoid any damage to the lignified ground shoots or trunks of the crop plants.

To ensure good ground contact during operation, it is advantageous for the harrow to have a spring element.

In a preferred embodiment, the harrow comprises at least two tines arranged in parallel. Preferably, the at least two parallel arranged tines each have two opposite ends, wherein the at least two parallel arranged tines are connected to each other at one end. In this way, a further improvement in weed control can be achieved.

According to a preferred embodiment, the tillage device comprises a rotating tillage device such as a roller weeder or a finger weeder.

The use of the harrow in combination with a rotating tillage device has proven to be particularly advantageous. The rotating tillage device breaks up the soil. In the process, the undesirable weeds are torn out or damaged. The harrow is pulled by the agricultural vehicle in the direction of travel behind the tillage device over the soil thrown up by the rotating tillage device, which results in that the soil thrown up by the rotating tillage device is being leveled. In addition, the harrow ensures that the weeds that have already been thrown up or partially pulled out are completely pulled out, thus avoiding possible regeneration of the weeds.

Preferably, the device for mechanical weed control is used in plantations of crop plants that have a lignified ground shoot or a woody trunk. For example, the device for mechanical weed control can be used in vineyards, espalier fruit cultures, Christmas tree plantations or rose-growing.

The present invention also relates to a method for mechanical weed control in row crops with a lignified ground shoot or a woody trunk, using a device according to the invention, wherein said method is characterized by the following steps:

Positioning the agricultural vehicle adjacent to a row of crop plants; aligning the at least one tine of the harrow so that the tine tip contacts the ground to be worked in the region of the woody trunk or lignified ground shoot and is positioned at a lateral distance from the longitudinal side of the agricultural vehicle; pulling out weeds in the area of the woody trunk by guiding the vehicle along the row of crop plants and having the tine tip grasp the weeds.

With this method, the vehicle pulls the harrow and thus the tines over the ground. The harrow can be brought right up to the stem or trunk of the plant in order to also pull those weeds out of the soil that grow around the stem or trunk.

Herein, it has proven to be particularly advantageous that the tine tip, at least in sections, projects laterally beyond the woody trunk or lignified ground shoot of the crop plants standing in the row, wherein the length of the tine preferably is being selected such that, when the at least one tine is aligned, approximately 5% to 30% of the length of the tine arm projects through the row of plants to be worked.

Thus, also those plants are weeded that grow between the trunks or lignified ground shoots of the crop plants within the row. The at least one tine, at least in sections, is guided around the trunk or lignified ground shoot so that the weeds located in the immediate vicinity of the trunk or lignified ground shoot are removed.

In a preferred further development of the claimed method, a rotating tillage device is provided, which is arranged ahead of the harrow regarding the direction of travel, wherein the rotating tillage device breaks up the soil around the woody trunk of the row crop plants and/or damages the weeds or at least partially uproots them. Herein, the rotating tillage device is guided at a safe distance from the stem or tree trunk to avoid damaging the crop plant itself. The harrow can then engage directly with the stem or tree trunk to pull out the remaining weeds. In addition, the harrow levels the soil thrown up by the rotating tillage device if necessary.

### BRIEF DESCRIPTION OF THE DRAWINGS

Preferred embodiments are explained in more detail with reference to the accompanying drawings, in which

FIG. 1 shows a section of an agricultural vehicle with a finger weeder and a first type of harrow,

FIG. 2 shows a finger weeder and a second type of a harrow,

FIG. 3 shows a section of an agricultural vehicle with a roller weeder and a second type of harrow,

FIG. 4 shows a top view of the embodiment shown in FIG. 3,

FIG. 5 shows a connecting element and

FIG. 6 shows a partial view of an agricultural vehicle with a roller weeder and a harrow according to a third type.

### BEST WAY TO CARRY OUT THE INVENTION

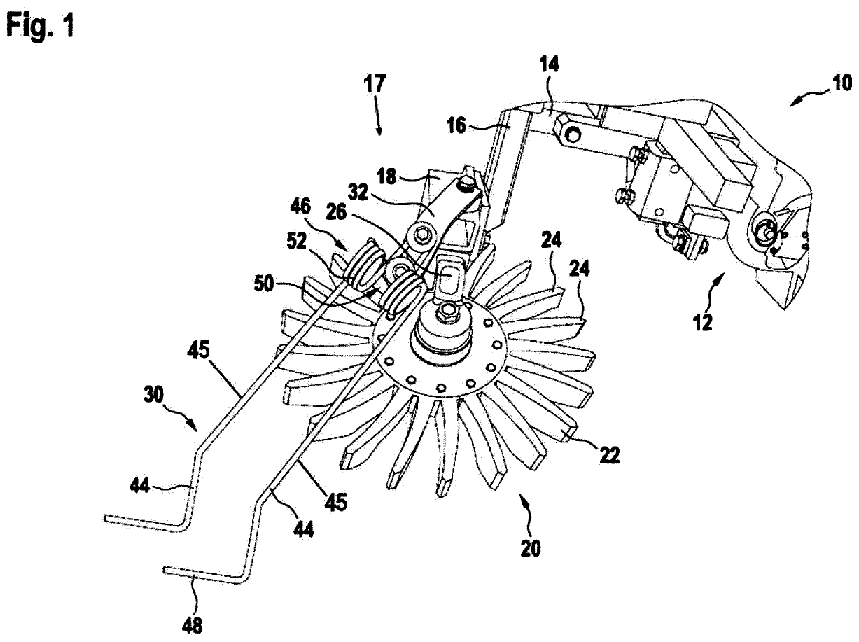

FIG. 1 shows an agricultural vehicle 10, of which only the rear side 12 can be seen. An attachment frame 14 is attached to the rear side 12 of the agricultural vehicle 10, wherein an attachment bar 16 formed on the attachment frame 14 is provided, to which a tillage device 17 with two soil cultivation tools is attached. The tillage device 17 comprises a holder 18, which in turn is connected to the attachment bar 16.

The holder 18 is part of a finger weeder 20, the finger weeder 20 being a rotary soil cultivation tool with a circular finger disc 22 having a circular inner element and a plurality of fingers 24, the fingers 24 being arranged along the outer edge of said inner element and extending radially outwardly. The inner element of the finger weeder 20 is rotatably mounted on the holder 18 so that the finger disc 22 is rotatable about its axis.

The holder 18 of the finger weeder 20 comprises a connecting bar 26, rectangular in cross-section, which is connected to the attachment bar 16 of the attachment frame 14 forming an angle, preferably forming a right angle.

Furthermore, a harrow 30 is provided as a second soil cultivation tool. In operation, the harrow is firmly connected to the holder 18. However, a lockable adjustment device is provided for setting a setting angle of the harrow 30.

The harrow 30 is connected to the connecting bar 26 of the holder 18 of the finger weeder 20 by means of a connecting element 32.

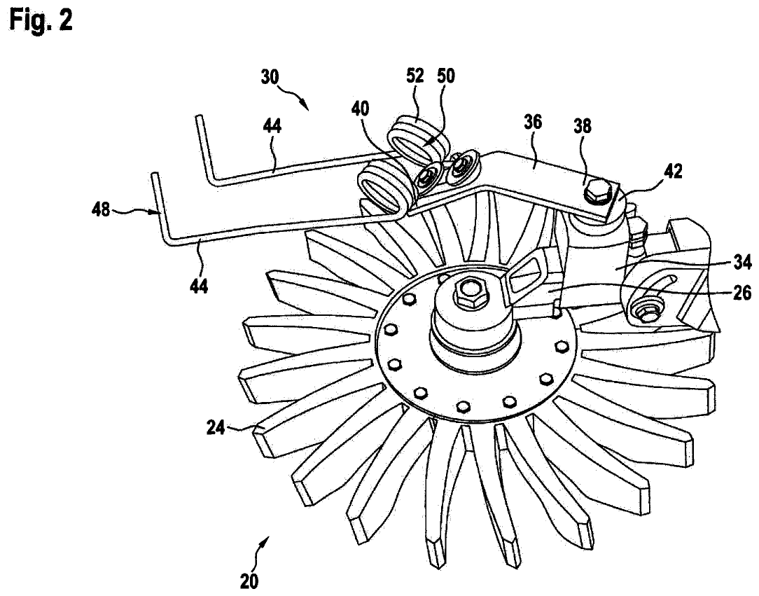

The connecting element 32 has a first connecting arm 34 and a second connecting arm 36 (see FIG. 2). The first connecting arm 34 is formed as an attachment with a rectangular cross-section, which is arranged on the connecting bar 26 of the holder 16 of the finger weeder 20 and is firmly attached to the connecting bar 26. The second connecting arm 36 is a flat elongated connecting plate with two opposite ends 38, 40.

A toothed joint 42 is provided on the upper side of the attachment, which is connected to an end 38 of the second connecting arm 36, so that the connecting element 32 has an adjustment device in the form of a lockable joint connection. The harrow 30 is attached to the free end 40 of the second connecting arm 36.

Relating to the direction of travel of the agricultural vehicle 10, the harrow 30 is arranged behind the finger weeder 20. The harrow 30 projects laterally beyond the longitudinal side of the agricultural vehicle, it is aligned at an angle to the direction of travel that can be adjusted by means of the toothed joint 42 and is inclined downwards.

The harrow 30 as such includes two parallel tines 44, each having a tine arm 45 with two opposite ends. The two opposite ends respectively form a tine base 46 and a tine tip 48.

The two tines 44 are connected to each other at the tine base 46 by means of a base element 50. The base element 50 is attached to the free end 40 of the second connecting arm 36. Furthermore, the tines 44 each have a spring element 52, which is formed as a coil. The two spring elements 52 are provided on the base 50 on both sides of the connection point with the second connecting arm 36. The tine tips 48 engage the ground during operation.

The harrow 30 as such consists of a spring steel with a predetermined diameter and is formed springily. The diameter of each tine 44 and the size and number of coils of the spring element 52 influence the hardness with which the harrow 30 works the soil.

FIG. 1 shows a first embodiment of a harrow 30 in which the tine tip 48 is bent at a predetermined angle relative to the tine arm 45, thus forming a first bend. A further bend is provided in the tine tip 48, so that the tine tip 48 here has a serrated shape.

FIG. 2 shows a tine 44, the tine tip 48 of which is bent at a predetermined angle relative to the tine arm 45 and is hook-shaped.

In order to use the tillage device described in FIGS. 1 and 2 in a vineyard or espaliered orchard, the agricultural vehicle is first positioned adjacent to the row of the crop to be tilled, such as a row of vines or fruit trees. The tines 44 are aligned so that the tine tips 48 contact the ground in the area of the trunks of the vines or fruit trees. The distance between the agricultural vehicle and the trunks of the vines or fruit trees is ideally set in a way that the tine arm 45, and thus the tine tip 48, projects slightly beyond the trunks. It has been found advantageous that the length of the tine 44 that projects through the row of plants is approximately 5% to 30% of the length of tine arm 45.

The tines 44 are oriented rearward and inclined downward in the direction of travel. The angle of the tine 44 relative to the horizontal is less than 45°, preferably less than 30°. Further, the tine 44 is adjustable with respect to the direction of travel at an angle between 20° and just below 90°. Preferably, the angle of the tine 44 with respect to the direction of travel of the agricultural vehicle is between 30° and 80°.

Now, when the agricultural vehicle travels along the row of crop plants, the finger weeder 20 uproots or damages the weeds between the rows of crop plants. The harrow 30 following the finger weeder 20 furthermore grasps the weeds between the trunks. Herein, the two tines 44 of the harrow 30 are guided, at least in sections, along the trunk or lignified ground shoot of the crop plant. Since the tines 44 are formed springily, there is no risk of damaging the trunk or the lignified ground shoot.

It goes without saying that the tillage device described in FIGS. 1 and 2 can also be used in other plantations in which the crop plants have a trunk or lignified ground shoot and are planted in rows.

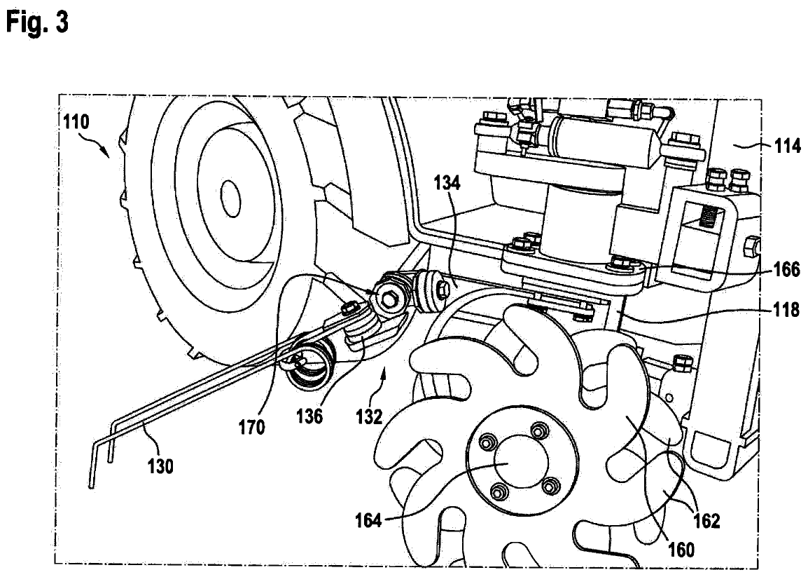

FIGS. 3 to 5 show a second embodiment of an agricultural vehicle 110 with a tillage device comprising a rotating soil cultivation tool in the form of a roller weeder 160 and a harrow 130.

In the embodiment shown in FIGS. 3 to 5, the roller weeder 160 is attached to the side of an agricultural vehicle 110.

The roller weeder 160 comprises two parallel and spaced rolling discs 162, which are rotatably mounted about a common axis 164 (see FIG. 3). Perpendicular to the axis of rotation of the rolling discs 162 a holder 118 of the roller weeder 160 is provided, which in turn is attached to an attachment frame 114 of an agricultural vehicle 110. The attachment frame 114 may be, for example, a lifting device that is commonly attached to agricultural vehicles.

The roller weeder 160 has a setting angle relative to the agricultural vehicle 110. The holder 118 of the roller weeder 160 has a pivoting device 166, by help of which the setting angle of the roller weeder 160 relative to the agricultural vehicle 110 can be changed manually or automatically.

The harrow 130 is firmly connected to the holder 118 of the roller weeder 160 via a connecting element 132. Again, a lockable adjustment device 170 is provided for setting the setting angle of the harrow 130.

The connecting element 132 includes a first connecting arm 134 and a second connecting arm 136. The first connecting arm 134 is elongated and has two ends, wherein the first connecting arm 134 is attached to the holder 118 of the roller weeder 160 in the region of one end below the pivoting device 166. At the other end, the adjustment device 170 is provided. The second connecting arm 136 is formed as a plate-shaped element and has two opposite ends, one end being connected to the harrow 130 and the other end being connected to the adjustment device 170.

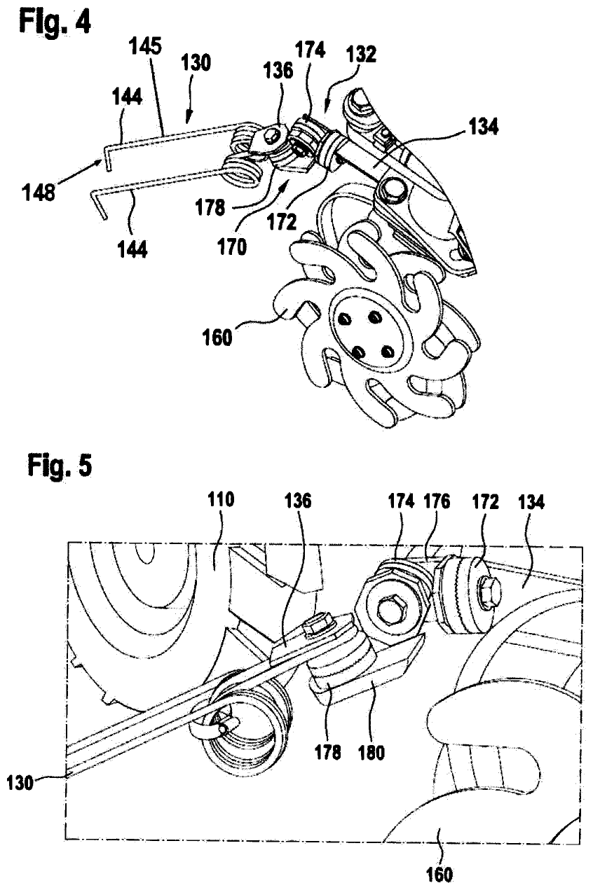

As illustrated in FIG. 4, the harrow 130 shows an angle with respect to the direction of travel of the agricultural vehicle 110. Herein, the harrow 130 is angled downwards and rearwards. The harrow 130 is also oriented at an angle with respect to the roller weeder 160, such that the angle at which the harrow 130 is oriented with respect to the agricultural vehicle 110 is different from the setting angle of the roller weeder 160.

The harrow 130 has a hook-shaped tine tip, which is formed in that the tine tip 144 is bent at a predetermined angle relative to the tine arm 145.

The adjustment device 170 is a series of three toothed joints whose pivot axes point in different spatial directions so that the harrow 130 can be adjusted in as many spatial directions as possible. Herein, the three toothed joints are arranged in such a way that two adjacent toothed joints each have an axis of rotation that is aligned perpendicular to the other.

In FIGS. 4 and 5 the adjustment device 170 is shown in detail.

The first toothed joint 172 is positioned at the end face of the first connecting arm 134 and has an axis of rotation perpendicular to the end face of the first connecting arm 134. The second toothed joint 174 is attached to a lateral axial extension 176 of the first toothed joint 172, with the axis of rotation of the second toothed joint 174 being oriented perpendicularly to the axial extension 176. The third toothed joint 178 has two opposing sides, one side being attached to a side surface of the plate-shaped second connecting arm 136. On the other side of the third toothed joint 178, a plate-shaped intermediate element 180 is attached to the third toothed joint 178 parallel to the second connecting arm 136. Herein, the intermediate element 180 is in turn connected to the second toothed joint 174. The axis of rotation of the third toothed joint 178 is perpendicular to the second connecting arm 136.

This adjustment device 170 can be used, for example, to adjust the height of the harrow 130 as well as the angle relative to the direction of travel. Furthermore, the inclination of the harrow 130 can be adjusted in relation to the ground to be worked.

In the embodiments illustrated in FIGS. 3 to 5, the setting angle of the tine 144 with respect to the horizontal has a value of less than 30°. In an embodiment not shown, the setting angle of the tine 144 with respect to the horizontal can have a value of up to 45°, preferably less than 30°.

Even if the setting angle between the horizontal and the tine 144 may be close to zero, a setting angle greater than 15° is advantageous.

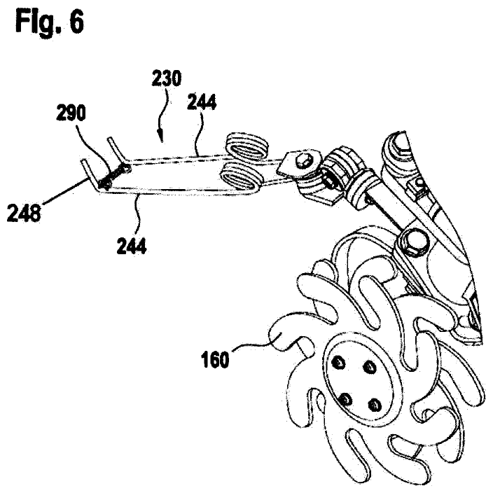

FIG. 6 shows another embodiment of a harrow 230 in combination with a roller weeder 260, in which additionally a metal chain 290 is provided between the two substantially right-angled, hook-like tine tips 248, which interconnects the two tines 244.

The operation of the tillage device described in FIGS. 3 to 6 is similar to the tillage device shown in FIGS. 1 to 2.

First, the agricultural vehicle is positioned adjacent to the row of crop plants, such as a row of vines or fruit trees, to be worked. The tines 144 are oriented so that the tine tips 148 contact the ground around the crop plants, such as vines or fruit trees, and are angled rearward regarding the direction of travel of the agricultural vehicle.

The distance between the agricultural vehicle and the trunk or lignified ground shoot of the crop plant is ideally set so that the tine tip 148 extends beyond each trunk. Again, it has been found advantageous that the length of the tine 144 which projects through the row of crop plants during operation is approximately 5% to 30% of the length of the tine arm 145.

The roller weeder 160 is located at a distance from the trunks or lignified shoots to avoid damaging the crop. When the agricultural vehicle drives along the crop plants, the roller weeder 160 breaks up the soil between two rows of crop plants. This way some of the weeds are already uprooted. The harrow 130 following the roller weeder 160 grasps the weeds that are in the area of the trunks and between the trunks or lignified shoots. Herein, the two tines 144 of the harrow 130 are guided, at least in sections, along the trunk or lignified ground shoot of the crop plant. At the same time, the harrow 130 levels the soil thrown up by the roller weeder 160.

It has proven advantageous to use a harrow with two tines. However, within the scope of the present invention, harrows with only tine one or more than two tines can also be used.

In an embodiment not shown, the tillage device only comprises a harrow. The use of a device for mechanical weed control comprising only a harrow is particularly useful if the soil around the crop plants is very soft, in particular sandy, or if the soil has already been broken up in another operation.

All embodiments have in common that, in particular when the device is used for mechanical weed control in a vineyard, the base of the tine attached to the agricultural vehicle is arranged at a predetermined distance from the soil to be worked. Both, a tine attached to the adjustment device and a tine attached directly to the attachment frame have a distance of about 20 cm to 70 cm, preferably of about 20 cm to 50 cm, between their base and the soil to be worked or the bearing surface of the wheels of the agricultural vehicle, in order to allow the vine to be worked in the area of the trunk without damaging the shoots.

The adjustment device described in connection with the roller weeder can also be used in other embodiments. For example, the adjustment device described in connection with FIGS. 3 to 5 can also be used instead of the adjustment device described in FIGS. 1 and 2. Alternatively, the adjustment device described in connection with the roller weeder can also be used in an embodiment in which the tilling device comprises a harrow only.

It goes without saying that the tine tips shown may be at any angle relative to the tine arm to form a bend. Additionally or alternatively, bends may be provided at any angle in the tine arm and/or tine tip.

Any of the harrows disclosed in the description can be used in combination with both a finger weeder and/or a roller weeder. Likewise, the features disclosed in connection with one embodiment can be combined with each other.

1. A device for mechanical weed control comprising an agricultural vehicle (10; 110) having a predetermined direction of travel and two opposite longitudinal sides, and a tillage device attached to the agricultural vehicle (10; 110),
wherein the tillage device comprises at least one harrow (30; 130; 230) having at least one tine (44; 144; 244) comprising a tine arm (45; 145), a tine tip (48; 148; 248) and a tine base (46; 146),
wherein the tine tip (48; 148; 248) and the tine base (46; 146) are located at opposite ends of the tine arm, and
wherein the harrow (30; 130; 230) is connected in the region of the tine base (46; 146) to a connecting element (32; 132), the at least one tine (44; 144; 244) of the harrow (30; 130; 230) has a bend with a predetermined angle, in that at least the tine tip (48; 148; 248) projects beyond a longitudinal side of the agricultural vehicle (10; 110) and in that the tine arm (45; 145) is oriented at a predetermined angle with respect to the direction of travel and in that the tine arm (45; 145) is inclined downwards.

2. The device according to claim 1, characterized in that at least one bend is provided in the tine (44; 144; 244) formed in the tine tip, in the tine arm, or between the tine tip (48; 148; 248) and the tine arm (45; 145).

3. The device according to claim 1, characterized in that the tine arm (45; 145) is inclined rearwards regarding the direction of travel.

4. The device according to claim 1, characterized in that the setting angle of the tine arm (45; 145) with respect to the horizontal is less than 45°.

5. The device according to claim 1, characterized in that the vertical distance of the tine base (46; 146) from a contact surface of the agricultural vehicle (10; 110) is about 20 cm to 70 cm.

6. The device according to claim 1, further including an adjustment device (170) configured to adjust the harrow (30; 130; 230) relative to the agricultural vehicle (10; 110) in at least one spatial direction.

7. The device according to claim 6, characterized in that the adjustment device (170) comprises at least one lockable joint.

8. The device according to claim 6, characterized in that the adjustment device (170) is firmly connected to the connecting element (32; 132) of the harrow (30; 130; 230).

9. The device according to claim 1, characterized in that the at least one tine (44; 144) has a spring.

10. The device according to claim 1, characterized in that the harrow (30; 130; 230) comprises a spring element (52).

11. The device according to claim 1, characterized in that the harrow (30; 130; 230) comprises at least two tines (44; 144) arranged in parallel.

12. The device according to claim 1, characterized in that the tillage device comprises a rotating tillage device such as a roller weeder (160; 260) or a finger weeder (20).

13. Use of the mechanical weed control device according to claim 1 in plantations of crop plants having a lignified ground shoot or a woody trunk.

14. A method for mechanical weed control in row crops having a lignified ground shoot or a woody trunk, comprising a mechanical weed control device according to claim 1 characterized by the following steps:
Positioning the agricultural vehicle adjacent to a row of crop plants;
aligning the at least one tine (44; 144) of the harrow (30; 130; 230) so that the tine tip (48; 148; 248) contacts the ground to be worked in the region of the woody trunk and is positioned at a lateral distance from the longitudinal side of the agricultural vehicle (10; 110);
pulling out weeds in the area of the woody trunk by guiding the agricultural vehicle (10; 110) along the row of crop plants and having the tine tip (48; 148; 248) grasp the weeds.

15. The method according to claim 14, characterized in that when aligning the at least one tine (44; 144; 244) of the harrow (30; 130; 230), the tine tip, at least in sections, projects laterally beyond the woody trunk of the crop plants standing in a row, wherein preferably the length of the tine (44; 144; 244) is being selected such that when the at least one tine (44; 144; 244) is aligned, approximately 5% to 30% of the length of the tine arm (45; 145) project through the row of plants to be worked.

16. The method according to claim 14, characterized in that a rotating tillage device is provided, which is arranged ahead of the harrow (30; 130; 230) regarding the direction of travel of the agricultural vehicle (10; 110), wherein the rotating tillage device rips up the soil around the woody trunk or lignified ground shoot of the row crop plants and/or uproots or damages the weeds.

17. The device according to claim 4, wherein the setting angle of the tine arm (45; 145) with respect to the horizontal is less than 30°.

18. The device according to claim 5, wherein the vertical distance of the tine base (46; 146) from the contact surface of the agricultural vehicle (10; 110) is 20 cm to 50 cm.

19. The device according to claim 6, wherein the adjustment device (170) is configured to adjust the harrow (30; 130; 230) relative to the agricultural vehicle (10; 110) in three mutually perpendicular spatial directions.

20. The device according to claim 7, wherein said at least one lockable joint is a toothed joint (42; 172, 174, 178).
